(19) United States
(12) Patent Application Publication
(10) Pub. No.: US 2026/0362019 A1
(43) Pub. Date: Nov. 12, 2026

(54) MITIGATION OF DUST ON CAMERA USING ULTRAVIOLET (UV) RADIATION TREATMENT

(71) Applicant: MOTOROLA MOBILITY LLC, WILMINGTON, DE (US)

(72) Inventors: AMIT KUMAR AGRAWAL, BANGALORE (IN); MANOJ JAIN, BANGALORE (IN); VENKAT RAO HARSHALA, BENGALURU (IN)

(21) Appl. No.: 19/094,952

(22) Filed: Mar. 30, 2025

(51) Int. Cl. H04N 23/81; B08B 6/00; B08B 7/00; B08B 7/04; B08B 11/04; B08B 13/00; G02B 27/00; H04N 23/60; H04N 23/67; H04N 23/69

(52) U.S. Cl. CPC H04N 23/811; B08B 6/00; B08B 7/0057; B08B 7/04; B08B 11/04; B08B 13/00; G02B 27/0006; H04N 23/64; H04N 23/67; H04N 23/69

(57) ABSTRACT

An electronic device provides various techniques for automatically mitigating dust on a camera using ultraviolet (UV) light and an electrostatically charged metallic ring to improve image capture. The electronic device includes a camera having a lens and an outer glass. The metallic ring is positioned at a periphery of the outer glass and electrically coupled to an electrostatic generator. A UV radiation source positioned to transmit UV light through the lens to illuminate a surface of the outer glass. A processor is configured to cause the electronic device to activate the UV radiation source to illuminate particles on the surface of the outer glass to positively electrostatically charge the particles. The processor triggers the electrostatic generator to provide an electrostatic charge to negatively charge the metallic ring, attracting positively charged particles to the periphery of the outer glass, mitigating image degradation during image capture by the camera.

### BACKGROUND

### 1. Technical Field

The present disclosure relates generally to electronic devices having integral camera(s), and more particularly, to mobile electronic devices having integral camera(s) and camera user interfaces.

### 2. Description of the Related Art

Portable electronic communication devices, particularly smartphones, have become ubiquitous. People all over the world use such devices to stay connected. With incorporation of front and back cameras and graphical displays, mobile devices are used frequently for capturing and replaying or sharing visual content such as photographic images and video recordings. Smartphones are carried by a user and exposed to ambient environmental conditions, including airborne particles such as dust. In order to capture high quality images and videos, the outer glass of a camera has to be kept clean. Frequently, the users proceed with capturing images and videos without giving thought to the condition of the outer camera glass. Even if the user proactively thinks to check the outer glass of the camera, the user may not have an appropriate cloth on hand to complete the cleaning.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to be advantageously implemented, according to one or more embodiments;

FIG. 1B is an additional block diagram representation of the electronic device of FIG. 1A presenting additional components, including components for wireless communications with other devices, according to one or more embodiments;

FIG. 2A is a simplified block diagram of operative components and example implementation of the electronic device with a dust-mitigating camera controlled by a camera lens dust mitigation (CLDM) module for automatically detecting and electrostatically removing particles from an outer glass in part by using an ultraviolet (UV) source, according to one or more embodiments;

FIG. 2B is a diagram of the UV source negatively charging dust particles on the outer glass, according to one or more embodiments;

FIG. 2C is a diagram of an electrostatic generator positively charging a metallic ring to move the charged dust particles to a periphery of the outer glass to improve image capture by the dust-mitigating camera, according to one or more embodiments;

FIG. 3 illustrates a touch display of the electronic device presenting camera control affordances and notifications regarding dust mitigation features, according to one or more embodiments;

FIG. 4 is a flow diagram presenting a computer-implemented method for using UV light and an inversely electrostatically charged metallic ring for dust mitigation, according to one or more embodiments; and

FIG. 5 is a flow diagram presenting a second computer-implemented method augmenting the method of FIG. 5 with automated detection of dust particles, adjusting field of view of the camera after moving the particles to a periphery of the outer glass, and presentation of notifications related to the dust mitigation, according to one or more embodiments.

### DETAILED DESCRIPTION

According to aspects of the present disclosure, an electronic device, a method, and a computer program product provide various techniques for dust mitigation for a camera of the electronic device using ultraviolet (UV) light and an inversely electrostatically charged metallic ring positioned at a periphery of an outer glass of the camera. The various techniques address a common problem faced by users of cameras that accumulate dust on the exterior glass surface, e.g., due to environmental conditions. Dust particles on optical components such as the outer glass of the camera impact image quality such as by making the captured image appear blurry and out of focus. The impact to image quality may be visible smudges, spots, or streaks partially blocking the captured image. Although a user may manually clean off the accumulated dust with a soft cloth, users of portable devices do not typically carry or remember to bring a soft cloth for camera lens cleaning. Even if a soft cloth is available, the user may not proactively clean the lens or may not have time to clean the lens when wanting to capture an image of a transient event.

The present disclosure addresses these and other challenges by exposing dust particles to high-energy ultraviolet (UV) photons that knock electrons off of a surface of the dust particles, giving the particles a net positive charge. The UV photons need to be energetic enough to overcome the ionization threshold of the particles. Lasers emitting in the UV-C range (i.e., 200-280 nm wavelength) are particularly effective, as their high-energy photons interact with dust and air molecules causing direct ionization with ions attaching to dust particles, charging them. Once ionized, the charged particles can be manipulated or captured using electrostatic fields or filters, preventing the charged particles from remaining on or settling on sensitive surfaces such as the outer glass of a camera lens.

According to one or more embodiments, an electronic device includes a camera having a lens and an outer glass. The electronic device includes a metallic ring peripherally positioned at a periphery of the outer glass. The electronic device includes an electrostatic generator electrically coupled to the metallic ring. The electronic device includes a UV radiation source positioned to transmit UV light through the lens to illuminate a surface of the outer glass. The electronic device includes a memory having a camera lens dust mitigation module. A processor of the electronic device is communicatively coupled to the camera, the electrostatic generator, the UV radiation source, and the memory. The processor is configured to cause the electronic device to activate the UV radiation source to illuminate particles on the surface of the outer glass to positively electrostatically charge the particles. The processor is configured to cause the electronic device to trigger the electrostatic generator to provide an electrostatic charge to negatively charge the metallic ring, attracting positively charged (dust) particles to the periphery of the outer glass.

According to one or more embodiments, a computer-implemented method is provided for using UV light and an inversely electrostatically charged metallic ring for dust mitigation. The method includes activating an ultraviolet (UV) radiation source positioned to transmit UV light through a lens to illuminate a surface of an outer glass of a camera of an electronic device to illuminate particles on the surface of the outer glass to positively electrostatically charge the particles. The method includes triggering an electrostatic generator electrically coupled to a metallic ring peripherally positioned on a periphery of the outer glass to provide an electrostatic charge to negatively charge the metallic ring, attracting positively charged particles to the periphery of the outer glass.

Further embodiments provide a computer program product that includes: a non-transitory computer readable medium; and program code on the computer readable medium that, when processed by a processor of an electronic system, configures the processor and/or the electronic system to perform functions of the above-described method.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent within the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized, and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc., do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

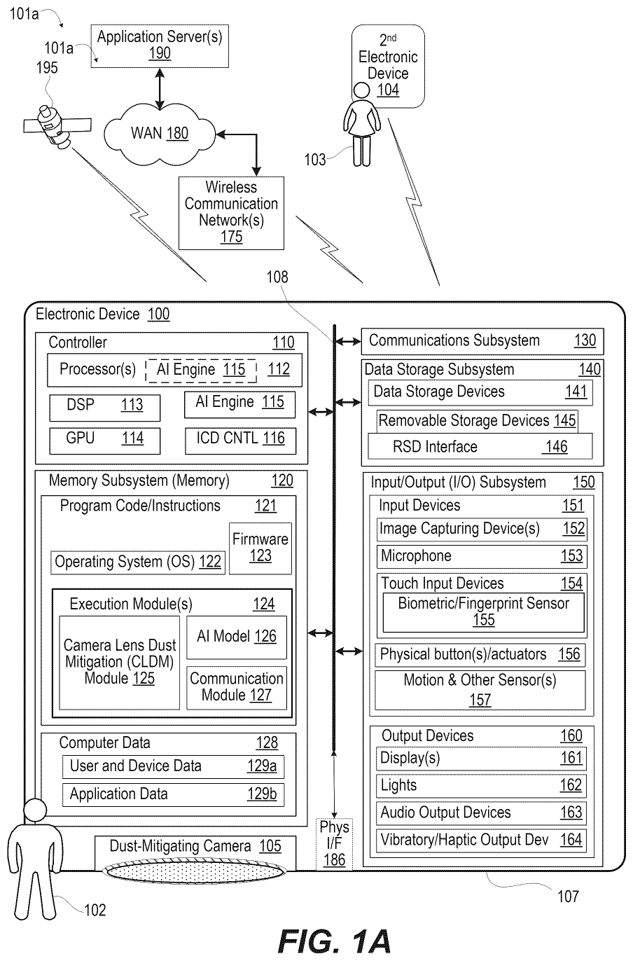

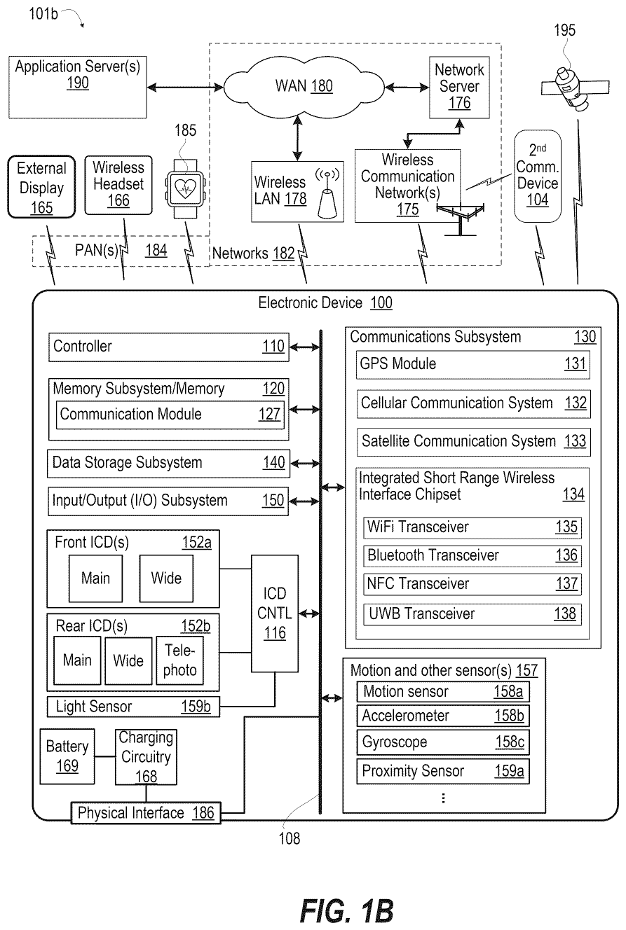

Those of ordinary skill in the art will appreciate that the hardware components and basic configuration depicted in the following figures may vary. For example, the illustrative components within electronic device 100 (FIG. 1A-1B) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, operational, or otherwise) on the described embodiments.

Referring now to the figures and beginning with FIG. 1A, there is illustrated a block diagram of an example electronic device 100 having dust mitigating camera 105 in communication environment 101a and having hardware and software components, which enable the features of the present disclosure to be advantageously implemented, according to one or more embodiments. Examples of electronic device 100 can include, but are not limited to, mobile devices, a notebook computer, vehicle-integrated communication system, a mobile phone, a smart phone, a digital camera with enhanced processing capabilities, a smart watch, a tablet computer, a heads-up display (e.g., smart glasses) worn by user 102, and other types of electronic devices. For purposes of this disclosure, electronic device is assumed to be a communication device that can be used to communicate with second user(s) 103 who use corresponding second electronic device(s) 104. Electronic device 100 can therefore be interchangeably referred to herein as a communication device. In one or more embodiments, electronic device 100 does not include communication functions.

Electronic device 100 generally includes controller 110, memory (or memory subsystem) 120, communication subsystem 130, data storage subsystem 140, input/output subsystem 150, all contained within or extended from an exterior surface of device housing 107. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113, graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of electronic device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122.

Memory subsystem (or memory) 120 may include a combination of volatile and non-volatile memory, such as random-access memory (RAM) and read-only memory (ROM). Memory subsystem 120 stores instruction or program code 121 for execution by processor 112 to configure processor 112 (and more generally electronic device 100) to provide the operational functions and features described herein. Instructions/program code 121 (or program code 121 for short) includes instructions for an operating system (OS) 122, firmware 123, such as basic input/output system (BIOS) or Uniform Extensible Firmware Interface (UEFI). Program code 121 includes execution module(s) 124 that collectively provides the various features of the disclosure. Execution module(s) 124 include, without limitation, camera lens dust mitigation (CLDM) module 125, which provides the features and operating functionality of the disclosed embodiments when the corresponding program instructions of CLDM module 125 are processed by/within processor 112/controller 110.

Execution modules 124 further includes AI model(s) 126. In one or more embodiments, processor 112 can utilize AI models 126 to provide AI functionality of processor-integrated AI engines 115. In other embodiments, AI models 126 are directly utilized by AI engine 115. In one or more embodiments, AI model 126 is integrated as a sub-module within CLDM module 125 and is trained to support the AI features of CLDM module 125. AI model(s) 126 may include an artificial neural network, a decision tree, a support vector machine, Hidden Markov model, linear regression, logistic regression, Bayesian networks, and so forth. AI model(s) 126 can be individually trained to perform specific tasks and can be arranged in different sets of AI models to generate different types of output. Training of AI model(s) 126 is the process by which AI models are trained to perform specific tasks or achieve certain objectives. The training involves providing the model with a large amount of data and allowing the model to learn from patterns and relationships within that data.

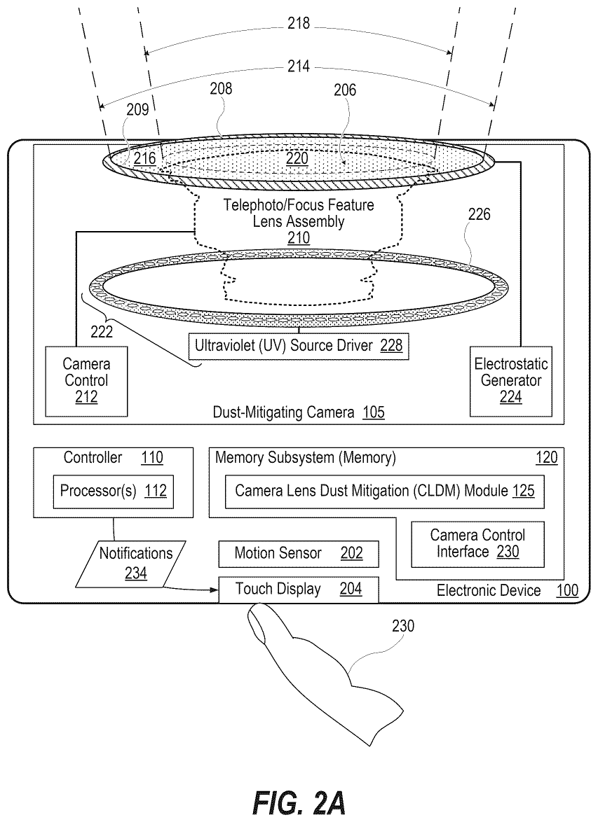

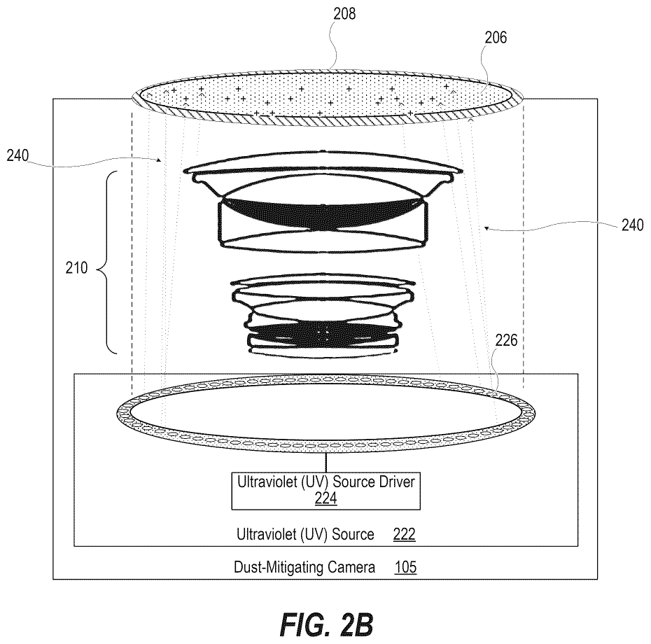

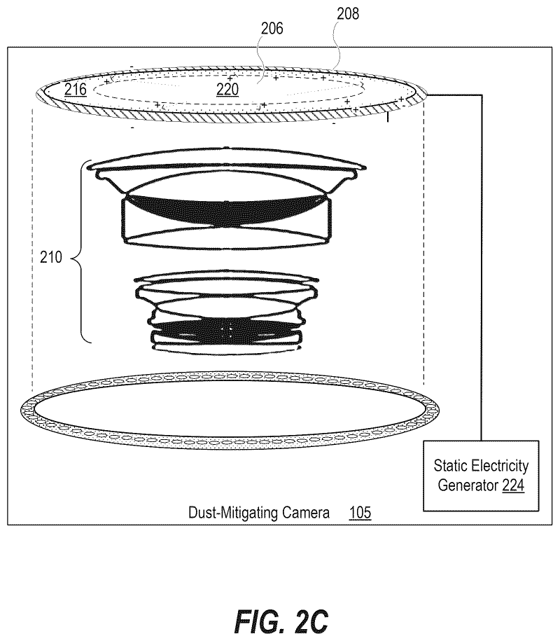

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, CLDM module 125 can include program instructions for automated detection of dust particles, adjusting field of view of the camera after moving the particles to a periphery of the outer glass, and presentation of notifications related to the dust mitigation. An example implementation of dust mitigating camera 105 and CLDM module 125 are described below with regard to FIGS. 2A-2C.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at electronic device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 104 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of electronic device 100 can include removable storage device(s) (RSD(s)) 145, which is received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of CLDM module 125 and AI model(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152 (e.g., dust mitigating camera 105), microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 107. Physical buttons/actuators 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description which.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detects movement of electronic device 100 and provides motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detects the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (e.g., touch input device 154) can be utilized as an input device. The touch screen interface (154) can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 107 along with front image capturing devices (not specifically shown), while the higher quality ICDs are located on a rear surface of device housing 107. Other embodiments provide multiple integrated displays within electronic device 100 and references to display(s) 161 are assumed to refer to one or all of these multiple integrated displays.

Vibration/haptic output device 164 can cause electronic device 100 to vibrate or shake when activated. Vibration/haptic output device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101b. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101b that includes other devices.

Communications subsystem 130 includes global positioning system (GPS) module 131 that enables electronic device to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to engage in long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a Wi-Fi router of a wireless local area network (WLAN) 178 and/or second electronic device 104, via one or more short-range wireless interface(s). Second electronic device 104 can be a communication device, such as a smartphone, and/or can be similarly configured as electronic device 100. Second user 103 may operate second electronic device 104. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of CLDM module 125 and/or access to other applications, online transactions, and resources.

In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 185. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 185, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 186. Physical interface 186 of electronic device 100 can serve as an input/output data port and can be used as a power supply port that is coupled to charging circuitry 168 which feeds electrical power to device battery 169 to enable recharging of device battery 169 and/or powering of electronic device 100. As a data port, physical interface 186 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICDs cameras 152b can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image and/or iris scan recognition.

FIG. 2A is a simplified block diagram of operative components and example implementation of electronic device 100 configured with dust-mitigating camera 105, controller 110, memory 120, motion sensor 202, and touch display 204. As illustrated by FIG. 2A, dust-mitigating camera 105 includes outer glass 206 with peripherally positioned metallic ring 208 at perimeter edge 209. Dust-mitigating camera 105 includes lens assembly 210. Dust-mitigating camera 105 includes camera control 212 for capturing images or videos and which may also control telephoto and auto-focus functions or features of lens assembly 210. In an example, camera control 212 may adjust lens assembly 210 to a wide field of view (FOV) 214 that includes periphery 216 of outer glass 206 adjacent to metallic ring 208. Camera control 212 may control lens assembly 210 to narrow FOV 218 that encompasses central portion 220 of outer glass 206 that excludes periphery 216. Dust-mitigating camera 105 includes using ultraviolet (UV) source 222 and electrostatic generator 224 for respectively positively charging dust particles on outer glass 206 and negatively charging metallic ring 208 to move positively charged dust particles to periphery 216 of outer glass 206. In an example, UV source 222 includes light emitting diode (LED) chips 226 powered by UV source driver 228.

Processor(s) 112 of controller 110 is configured by executing camera control interface 230 to cause electronic device 100 to operate camera control 212 in response to user inputs to hardware or software controls, such as finger 230 of user 102 (FIG. 1A) making selections via touch display 204. Processor(s) 112 of controller 110 is further configured by executing CLDM module 125 to cause electronic device 100 to perform dust mitigation.

FIG. 2B is a diagram of UV source 222 emitting UV-C radiation 240 through lens assembly 210 to negatively charging dust particles on outer glass 206 as part of dust mitigation. In an example, the activation of UV source 222 may automatically occur on a periodic schedule. Alternatively, or in addition, the activation of UV source 222 may be triggered by activation of camera control 212 (FIG. 2A). Alternatively, or in addition, the activation of UV source 222 may be triggered based on detection of a sufficient level of dust particle accumulation on outer glass 206. Alternatively, or in addition, the activation of UV source 222 may be triggered by a user input.

FIG. 2C is a diagram of electrostatic generator 224 positively charging metallic ring 208 to move the charged dust particles to periphery 216 of outer glass 206 in order to improve image capture by dust-mitigating camera 105 by providing cleared central portion 220. Manual or automatic adjustment of the field of view of lens assembly 210 to central portion 220 enables capture of higher quality image without dust particles and avoids degradation of the periphery of captured image by the repositioned dust particles. This adjustment of the FOV of lens assembly 210 can be applied until the user is able to clean the outer glass 206, e.g., by wiping the surface with a soft cloth. While depicted as round structures, outer glass 206 and metallic ring 208 may be different geometric shape than round, such as square, oval, rectangular, diamond shaped, etc., in other embodiments.

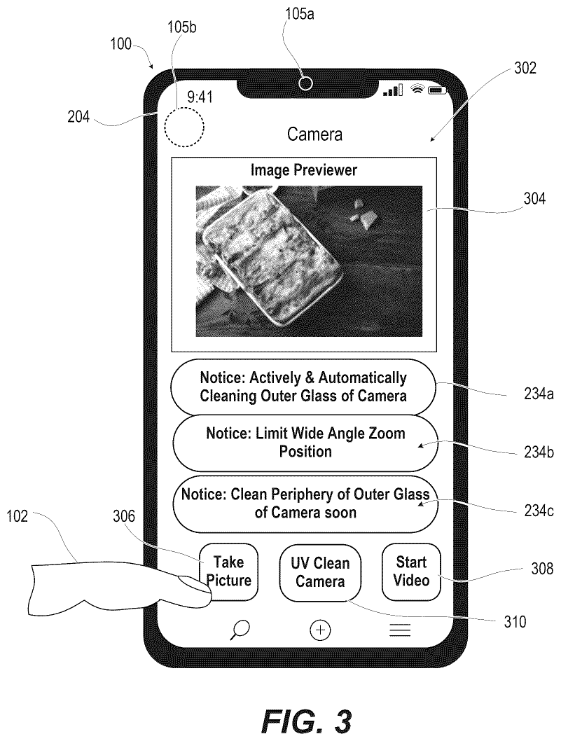

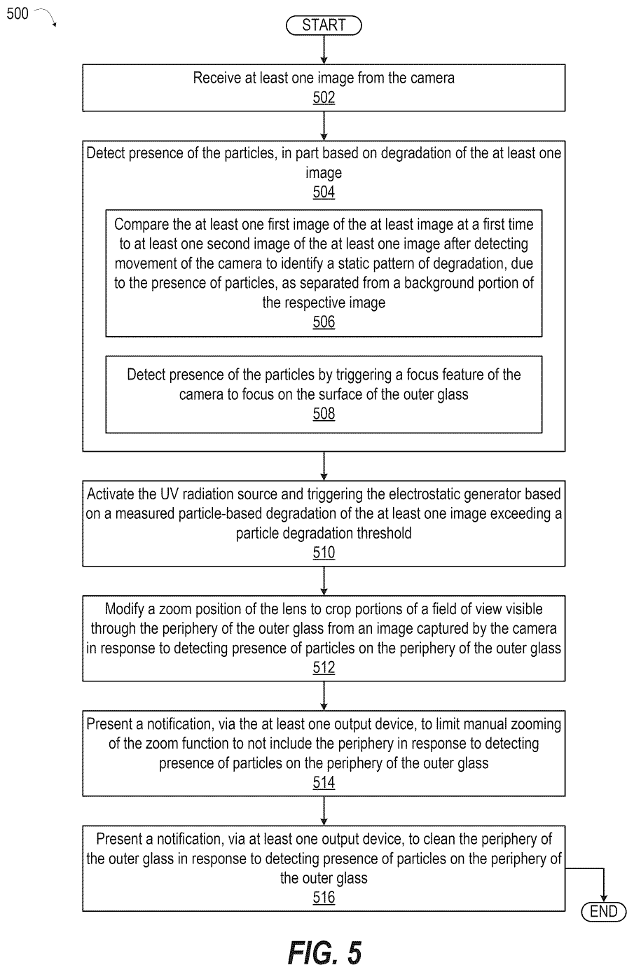

With reference primarily to FIG. 2A, in the example implementation, UV source driver 228 activates and electrically powers LED chips 226 of UV source 222 to positively charge dust particles as depicted and described above for FIG. 2B. Dust-mitigating camera 105 electrostatically moves particles charged by UV radiation from central portion 220 of outer glass 206 by inversely (i.e., negatively) charging metallic ring 208 as depicted and described above with regard to FIG. 2C. Processor(s) 112 of controller 110 is further configured by executing CLDM module 125 to cause electronic device 100 to generate and present notifications 234 via touch display 204 as depicted and described below with regard to FIGS. 3 and 5.

FIG. 3 illustrates touch display 204 of electronic device 100 presenting camera interface window 302 that includes camera preview 304 and camera control affordances, such as take picture control 306 and start video toggle control 308. Camera interface window 302 supports functions for dust mitigation. In an example, camera control affordances include UV clean camera control 310 selectable by user 102 to trigger UV/electrostatic cleaning of at least one of front dust-mitigating camera 105a and back dust-mitigating camera 105b. Camera interface window 302 may present first, second and third notifications 234a, 234b and 234c regarding dust mitigation features and functions. In an example, first notification 234a alerts user 102 that automatic cleaning of outer glass of camera is active. The alert may caution the user 102 to delay, if practical, triggering image capture. The alert may inform the user 102 of why image capture is automatically being disabled until cleaning is complete. In another example, second notification 234b may inform the user to adjust telephoto features of at least one of front dust-mitigating camera 105a and back dust-mitigating camera 105b to avoid dust particles that have been moved to the periphery. Alternatively, second notification 234b may explain to user 102 why wider telephoto field of view is being automatically disabled. In an additional example, third notification 234c reminds user 102 to clean the periphery of the outer glass of front and/or back dust-mitigating cameras 105a-105b. Third notification 234c may be triggered periodically to correspond to recommended intervals for cleaning with a soft cloth following the periodic UV ionization and metallic ring charging processes. Alternatively, or in addition, third notification 234c may be triggered based on detection of an amount of dust particle accumulation on the periphery of the outer glass of at least one of front and back dust-mitigating cameras 105a-105b. For clarity, touch display 204 includes visual notifications. In one or more alternate or additional embodiments, notifications may be aural or haptic.

Referring again to FIG. 2A, according to aspects of the present disclosure, electronic device 100 includes dust mitigating camera 105 having outer glass 206 and lens assembly 210. Dust mitigating camera 105 includes metallic ring 208 that is peripherally positioned at a periphery (i.e., perimeter edge 209) of outer glass 206. Dust mitigating camera 105 includes electrostatic generator 224 electrically coupled to metallic ring 208. Dust mitigating camera 105 includes ultraviolet (UV) radiation source 222 positioned to transmit UV light through lens assembly 210 to illuminate a surface of outer glass 206. Dust mitigating camera 105 includes memory 120 having camera lens dust mitigation (CLDM) module 125. Processor 112 is communicatively coupled to dust-mitigating camera 105, electrostatic generator 224, UV radiation source 222, and memory 120. Processor 112 is configured to cause electronic device 100 to activate UV radiation source 222 to illuminate particles on the surface of outer glass 206 to positively electrostatically charge the particles. Processor 112 is configured to cause electronic device 100 to trigger electrostatic generator 224 to provide an electrostatic charge to negatively charge metallic ring 208, attracting positively charged particles to periphery 216 of outer glass 206.

In one or more embodiments, while UV radiation source 222 and electrostatic generator are active, processor 112 is configured to cause electronic device 100 to disable camera control 212 to prevent capture of an image. Processor 112 is configured to cause electronic device 100 to re-enable camera control 212 following application of the electrostatic charge by electrostatic generator 224 to metallic ring 208.

In one or more embodiments, processor 112 is configured to cause electronic device 100 to receive at least one image from dust-mitigating camera 105. Processor 112 is configured to cause electronic device 100 to detect presence of the particles on the camera glass, in part based on degradation of the at least one image. Processor 112 is configured to cause electronic device 100 to activate UV radiation source 222 and trigger electrostatic generator 224 based on a measured particle-based degradation of the at least one image exceeding a particle degradation threshold.

In one or more particular embodiments, electronic device 100 includes motion sensor 202 that is communicatively coupled to processor 112. To detect presence of the particles, in part based on degradation of the at least one image, processor 112 is further configured to cause electronic device 100 to capture at least one first image received from dust-mitigating camera 105. Processor 112 is configured to cause electronic device 100 to monitor motion sensor 202 to detect movement of dust-mitigating camera 105. In response to detecting movement of dust-mitigating camera 105, processor 112 is further configured to cause electronic device 100 to capture at least one second image received from dust-mitigating camera 105. Processor 112 is configured to cause electronic device 100 to compare the at least one first image to the at least one second image to identify a static pattern of degradation, due to the presence of particles, as separated from a background portion of the respective image.

In one or more particular embodiments, dust-mitigating camera 105 includes a focus feature. Processor 112 is configured to cause electronic device 100 to detect presence of the particles by triggering the focus feature to focus on the surface of outer glass 206.

In one or more embodiments, electronic device 100 includes at least one output device (e.g., touch display 204) is communicatively coupled to processor 112. While UV radiation source 222 and electrostatic generator 224 are active, processor 112 is further configured to cause electronic device 100 to present, via at least one output device 160 (FIG. 1A), notification 234 indicating a current state of cleaning of outer glass 206.

In one or more particular embodiments, dust-mitigating camera 105 includes a zoom function that enables zooming in by lens assembly 210 to capture only a portion of a field of view (e.g., narrow FOV 218) that excludes periphery 216 of outer glass 206. Processor 112 is further configured to cause electronic device 100 to detect presence of particles on periphery 216 of outer glass 206. Processor 112 is configured to cause electronic device 100 to modify a zoom position of lens assembly 210 to crop, from an image captured by dust-mitigating camera 105, portions of wide FOV 214 that are visible through periphery 216 of outer glass 206.

In one or more particular embodiments, dust-mitigating camera 105 includes at least one output device 160 (FIG. 1A) that is communicatively coupled to processor 112. Dust-mitigating camera 105 includes a zoom function that enables zooming in by lens assembly 210 to capture only a portion (i.e., narrow FOV 218) of wide FOV 214 that is within periphery 216 of outer glass 206. Processor 112 is further configured to cause electronic device 100 to detect presence of particles on periphery 216 of outer glass 206. Processor 112 is further configured to cause electronic device 100 to present notification 234, via at least one output device 160 (FIG. 1A), to clean periphery 216 of outer glass 206.

In one or more particular embodiments, dust-mitigating camera 105 includes at least one output device 160 (FIG. 1A) that is communicatively coupled to processor 112. dust-mitigating camera 105 includes a zoom function that enables zooming-in by lens assembly 210 to capture only a portion (i.e., narrow FOV 218) of wide FOV 214 that excludes periphery 216 of outer glass 206. Processor 112 is further configured to cause electronic device 100 to detect presence of particles on periphery 216 of outer glass 206. Processor 112 is further configured to cause electronic device 100 to present notification 234, via at least one output device 160 (FIG. 1A), to limit manual zooming of the zoom function to not include periphery 216.

In one or more embodiments, processor 112 is further configured to cause electronic device 100 to monitor camera control 212 to detect activation of dust-mitigating camera 105. Processor 112 is further configured to cause electronic device 100 to activate UV radiation source 222 to illuminate the particles on the surface of outer glass 206 and trigger electrostatic generator 224 to provide the electrostatic charge in response to detecting activation of dust-mitigating camera 105.

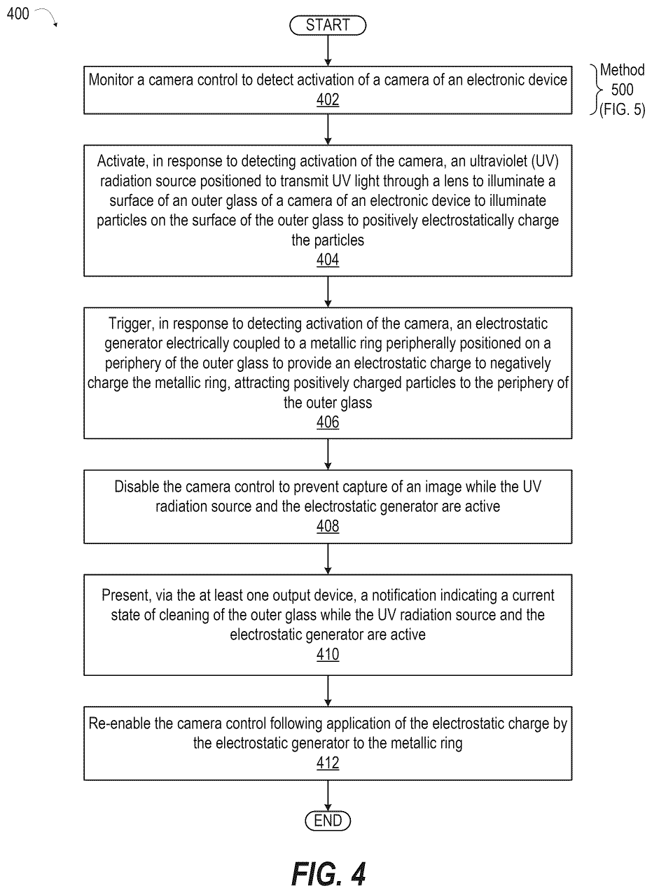

FIG. 4 is a flow diagram presenting computer-implemented method 400 for reducing image degradation due to particles on an outer glass of a camera by using ultraviolet (UV) light and an electrostatic ring. FIG. 5 is a flow diagram presenting computer-implemented method 500 augmenting method 400 (FIG. 4) with automated detection of dust particles, adjusting field of view of the camera after moving the particles to a periphery of the outer glass, and presentation of notifications related to the dust mitigation. The descriptions of method 400 (FIG. 4) and method 500 (FIG. 5) are provided with general reference to the specific components illustrated within the preceding FIGS. 1A-1B, 2A-2C , and 3. Specific components referenced in method 400 (FIG. 4) and method 500 (FIG. 5) may be identical or similar to components of the same name used in describing preceding FIGS. 1A-1B, 2A-2C , and 3. In one or more embodiments, controller 110 (FIG. 1A) configures electronic device 100 (FIGS. 1A-1B) or a similar computing device to provide the described functionality of method 400 (FIG. 4) and method 500 (FIG. 5).

With reference to FIG. 4, method 400 includes monitoring a camera control to detect activation of a camera of an electronic device (block 402). Alternatively, or in addition to triggering based on monitoring for activation of the camera, method 500 of FIG. 5 describes triggering based on automated detection of particles on the outer glass of the camera. Method 400 includes activating, in response to detecting activation of the camera, an ultraviolet (UV) radiation source positioned to transmit UV light through a lens to illuminate a surface of an outer glass of the camera of the electronic device to illuminate particles on the surface of the outer glass to positively electrostatically charge the particles (block 404). Method 400 includes triggering, in response to detecting activation of the camera and activation of the UV radiation source, an electrostatic generator electrically coupled to a metallic ring peripherally positioned on a periphery of the outer glass to provide an electrostatic charge to negatively charge the metallic ring, attracting positively charged particles to the periphery of the outer glass (block 406). Method 400 includes disabling the camera control to prevent capture of an image while the UV radiation source and the electrostatic generator are active (block 408). Method 400 includes presenting, via the at least one output device, a notification indicating a current state of cleaning of the outer glass while the UV radiation source and the electrostatic generator are active (block 410). Method 400 includes re-enabling the camera control following application of the electrostatic charge by the electrostatic generator to the metallic ring (block 412). Then method 400 ends.

With reference to FIG. 5, method 500 includes receiving at least one image from the camera (block 502). Method 500 includes detecting presence of particles, in part based on degradation of the at least one image (block 504) that may include performing one or more processes provided in blocks 506 and 508. Method 500 may include comparing the at least one first image of the at least image at a first time to at least one second image of the at least one image. The comparison is performed after detecting movement of the camera to identify a static pattern of degradation. The static pattern is due to the presence of particles as separated from a background portion of the respective image that change with movement of the camera (block 506). Method 500 may include detecting presence of the particles by triggering a focus feature of the camera to focus on the surface of the outer glass (block 508). Method 500 may include activating the UV radiation source and subsequently triggering the electrostatic generator based on a measured particle-based degradation of the at least one image exceeding a particle degradation threshold (block 510). Method 500 may include modifying a zoom position of the lens to crop portions of a field of view visible through the periphery of the outer glass from an image captured by the camera, in response to detecting presence of particles on the periphery of the outer glass (block 512). Alternatively, method 500 may include presenting a notification, via the at least one output device, to limit manual zooming of the zoom function to not include the periphery in response to detecting presence of particles on the periphery of the outer glass (block 514). Method 500 may include presenting a notification, via at least one output device, to clean the periphery of the outer glass in response to detecting presence of particles on the periphery of the outer glass (block 516). Then method 500 ends.

According to aspects of the present disclosure, electronic device 100 (FIG. 1A), method 400 (FIG. 4) and method 500 (FIG. 5), and computer program product, such as RSD 145 (FIG. 1A), provide techniques for improving image quality with dust mitigation for a camera of the electronic device using ultraviolet (UV) light and an inversely electrostatically charged metallic ring positioned at a periphery of an outer glass of the camera. The user is not inconvenienced and delayed in capturing an image (e.g., one or more digital photograph or video) by having to manually clean a surface of the outer glass.

Aspects of the present innovation are described above with reference to flowchart illustrations and/or block diagrams of methods, apparatus (systems) and computer program products according to embodiments of the innovation. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

As will be appreciated by one skilled in the art, embodiments of the present innovation may be embodied as a system, device, and/or method. Accordingly, embodiments of the present innovation may take the form of an entirely hardware embodiment or an embodiment combining software and hardware embodiments that may all generally be referred to herein as a “circuit,” “module” or “system.”

While the innovation has been described with reference to exemplary embodiments, it will be understood by those skilled in the art that various changes may be made, and equivalents may be substituted for elements thereof without departing from the scope of the innovation. In addition, many modifications may be made to adapt a particular system, device, or component thereof to the teachings of the innovation without departing from the essential scope thereof. Therefore, it is intended that the innovation not be limited to the particular embodiments disclosed for carrying out this innovation, but that the innovation will include all embodiments falling within the scope of the appended claims. Moreover, the use of the terms first, second, etc., do not denote any order or importance, but rather the terms first, second, etc. are used to distinguish one element from another.

The terminology used herein is for the purpose of describing particular embodiments only and is not intended to be limiting of the innovation. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present innovation has been presented for purposes of illustration and description but is not intended to be exhaustive or limited to the innovation in the form disclosed. Many modifications and variations will be apparent to those of ordinary skill in the art without departing from the scope and spirit of the innovation. The embodiments were chosen and described in order to best explain the principles of the innovation and the practical application, and to enable others of ordinary skill in the art to understand the innovation for various embodiments with various modifications as are suited to the particular use contemplated.

What is claimed is:

1. An electronic device comprising:
a camera comprising a lens and an outer glass;
a metallic ring peripherally positioned at a periphery of the outer glass;
an electrostatic generator electrically coupled to the metallic ring;
an ultraviolet (UV) radiation source positioned to transmit UV light through the lens to illuminate a surface of the outer glass;
a memory comprising a camera lens dust mitigation module; and
a processor communicatively coupled to the camera, the electrostatic generator, the UV radiation source, and the memory, and which is configured to cause the electronic device to:
activate the UV radiation source to illuminate particles on the surface of the outer glass to positively electrostatically charge the particles; and
trigger the electrostatic generator to provide an electrostatic charge to negatively charge the metallic ring, attracting positively charged particles to the periphery of the outer glass.

2. The electronic device of claim 1, wherein the processor is further configured to cause the electronic device to:
while the UV radiation source and the electrostatic generator are active, disable a camera control to prevent capture of an image; and
re-enable the camera control following application of the electrostatic charge by the electrostatic generator to the metallic ring.

3. The electronic device of claim 1, wherein the processor is further configured to cause the electronic device to:
receive at least one image from the camera;
detect presence of the particles, in part based on degradation of the at least one image; and
activate the UV radiation source and trigger the electrostatic generator based on a measured particle-based degradation of the at least one image exceeding a particle degradation threshold.

4. The electronic device of claim 3, further comprising a motion sensor communicatively coupled to the processor, and wherein, to detect presence of the particles, in part based on degradation of the at least one image, the processor is further configured to cause the electronic device to:
capture at least one first image received from the camera;
monitor the motion sensor to detect movement of the camera; and
in response to detecting movement of the camera:
capture at least one second image received from the camera; and
compare the at least one first image to the at least one second image to identify a static pattern of degradation, due to the presence of particles, as separated from a background portion of the respective image.

5. The electronic device of claim 3, wherein the camera comprises a focus feature, and the processor is further configured to cause the electronic device to detect presence of the particles by triggering the focus feature to focus on the surface of the outer glass.

6. The electronic device of claim 1, further comprising at least one output device communicatively coupled to the processor, and wherein the processor is further configured to cause the electronic device to:
while the UV radiation source and the electrostatic generator are active, present, via the at least one output device, a notification indicating a current state of cleaning of the outer glass.

7. The electronic device of claim 1, wherein the camera comprises a zoom function that enables zooming in by the lens to capture only a portion of a field of view that excludes the periphery of the outer glass, and the processor is further configured to cause the electronic device to:
detect presence of particles on the periphery of the outer glass; and
modify a zoom position of the lens to crop portions of a field of view visible through the periphery of the outer glass from an image captured by the camera.

8. The electronic device of claim 1, further comprising at least one output device communicatively coupled to the processor, and wherein the camera comprises a zoom function that enables zooming in by the lens to capture only a portion of a field of view that is within the periphery of the outer glass, and the processor is further configured to cause the electronic device to:
detect presence of particles on the periphery of the outer glass; and
present a notification, via the at least one output device, to clean the periphery of the outer glass.

9. The electronic device of claim 1, further comprising at least one output device communicatively coupled to the processor, and wherein the camera comprises a zoom function that enables zooming-in by the lens to capture only a portion of a field of view that excludes the periphery of the outer glass, and the processor is further configured to cause the electronic device to:
detect presence of particles on the periphery of the outer glass; and
present a notification, via the at least one output device, to limit manual zooming of the zoom function to not include the periphery.

10. The electronic device of claim 1, wherein the processor is further configured to cause the electronic device to:
monitor a camera control to detect activation of the camera; and
activate the UV radiation source to illuminate the particles on the surface of the outer glass and trigger the electrostatic generator to provide the electrostatic charge in response to detecting activation of the camera.

11. A method comprising:
activating an ultraviolet (UV) radiation source positioned to transmit UV light through a lens to illuminate a surface of an outer glass of a camera of an electronic device to illuminate particles on the surface of the outer glass to positively electrostatically charge the particles; and
triggering an electrostatic generator electrically coupled to a metallic ring peripherally positioned on a periphery of the outer glass to provide an electrostatic charge to negatively charge the metallic ring, attracting positively charged particles to the periphery of the outer glass.

12. The method of claim 11, further comprising:
monitoring a camera control to detect activation of the camera;
activating the UV radiation source to illuminate the particles on the surface of the outer glass and triggering the electrostatic generator to provide the electrostatic charge in response to detecting activation of the camera;
while the UV radiation source and the electrostatic generator are active, disabling the camera control to prevent capture of an image; and
re-enabling the camera control following application of the electrostatic charge by the electrostatic generator to the metallic ring.

13. The method of claim 11, further comprising:
capturing at least one first image received from the camera;
monitoring a motion sensor to detect movement of the camera; and
in response to detecting movement of the camera:
capturing at least one second image received from the camera;
comparing the at least one first image to the at least one second image to identify a static pattern of degradation, due to presence of particles, as separated from a background portion of respective images; and
activating the UV radiation source and triggering the electrostatic generator based on a measured particle-based degradation of the at least one image exceeding a particle degradation threshold.

14. The method of claim 11, further comprising:
triggering a focus feature of the camera, which enables zooming in by the lens to capture only a portion of a field of view that excludes the periphery of the outer glass, to focus on the surface of the outer glass; and
activating the UV radiation source and trigger the electrostatic generator based on a measured particle-based degradation of at least one image received from the camera exceeding a particle degradation threshold.

15. The method of claim 11, further comprising:
while the UV radiation source and the electrostatic generator are active, presenting, via at least one output device, a notification indicating a current state of cleaning of the outer glass.

16. The method of claim 11, further comprising:
detecting presence of particles on the periphery of the outer glass; and
operating a zoom function of the camera that enables zooming in by the lens to capture only a portion of a field of view that is within the periphery of the outer glass by modifying a zoom position of the lens to crop portions of a field of view visible through the periphery of the outer glass from an image captured by the camera.

17. The method of claim 16, further comprising:
detecting presence of particles on the periphery of the outer glass; and
presenting a notification, via at least one output device, to clean the periphery of the outer glass.

18. The method of claim 16, further comprising:
detecting presence of particles on the periphery of the outer glass of the camera, wherein the camera comprises a zoom function that enables zooming in by the outer glass to capture only a portion of a field of view that excludes the periphery of the outer glass; and
presenting a notification, via at least one output device, to limit manual zooming of the zoom function to not include the periphery.

19. A computer program product comprising:
a computer readable storage device; and
program code on the computer readable storage device that when executed by a processor associated with an electronic device, the program code is configured to cause the electronic device to provide functionality of:
activating an ultraviolet (UV) radiation source positioned to transmit UV light through a lens to illuminate a surface of an outer glass of a camera of the electronic device to illuminate particles on the surface of the outer glass to positively electrostatically charge the particles; and
triggering an electrostatic generator electrically coupled to a metallic ring to provide an electrostatic charge to negatively charge the metallic ring peripherally positioned at a periphery of the outer glass, attracting positively charged particles to the periphery of the outer glass.

20. The computer program product of claim 19, wherein the program code is configured to cause the electronic device to provide functionality of:
monitoring a camera control to detect activation of the camera;
activating the UV radiation source to illuminate the particles on the surface of the outer glass and triggering the electrostatic generator to provide the electrostatic charge in response to detecting activation of the camera;
while the UV radiation source and the electrostatic generator are active, disabling the camera control to prevent capture of an image; and
re-enabling the camera control following application of the electrostatic charge by the electrostatic generator to the metallic ring.
